(19) United States
(12) Patent Application Publication
(10) Pub. No.: US 2025/0299534 A1
(43) Pub. Date: Sep. 25, 2025

(54) SYMBOL LOCKING IN A SLOT GAME

(71) Applicant: IGT, Las Vegas, NV (US)

(72) Inventor: Ryan HANNAH, Lower Cloverdale (CA)

(73) Assignee: IGT, Las Vegas, NV (US)

(21) Appl. No.: 18/615,694

(22) Filed: Mar. 25, 2024

(51) Int. Cl. G07F 17/32; G07F 17/34

(52) U.S. Cl. CPC G07F 17/3267; G07F 17/3211; G07F 17/3239; G07F 17/34

(57) ABSTRACT

An electronic gaming machine (“EGM”) can display a grid of symbols as part of a slot game. The EGM can further determine that the grid of symbols includes a trigger symbol. The EGM can further determine that the grid of symbols includes a symbol associated with the trigger symbol. The EGM can further, responsive to determining that the grid of symbols includes the symbol associated with the trigger symbol and that the grid of symbols includes the trigger symbol, lock the symbol.

### BACKGROUND

Embodiments described herein relate to operations of electronic gaming machines (“EGMs”). EGMs can provide one or more games (e.g., wagering games) stored therein that can be played by a player. The EGM can provide a prize to the player based on a wager and an outcome of a wagering game. An example of a wagering game includes a slot game in which, in response to receiving a wager from the player, one or more rows of symbols are revealed. A prize can be provided to the player based on the one or more rows of symbols including one or more winning combinations of symbols.

### SUMMARY

According to some embodiments, a method of operating an electronic gaming machine (“EGM”) is provided. The method includes displaying a grid of symbols as part of a slot game. The method further includes determining that the grid of symbols includes a trigger symbol. The method further includes determining that the grid of symbols includes a symbol associated with the trigger symbol. The method further includes, responsive to determining that the grid of symbols includes the symbol associated with the trigger symbol and that the grid of symbols includes the trigger symbol, locking the symbol.

According to other embodiments, an electronic gaming machine (“EGM”) is provided. The EGM includes processing circuitry and memory coupled to the processing circuitry. The memory has instructions stored therein that are executable by the processing circuitry to cause the EGM to perform operations. The operations include displaying a first grid of symbols as part of a first play of a slot game. The operations further include determining that the first grid of symbols includes a scatter trigger symbol. The operations further include, responsive to determining that the first grid of symbols includes the scatter trigger symbol, locking a symbol of the first grid of symbols. The operations further include, subsequent to completing the first play of the slot game, displaying a second grid of symbols as part of a second play of the slot game, the second grid of symbols being determined to include the symbol based on the symbol having been locked.

According to other embodiments, a non-transitory computer readable medium is provided. The non-transitory computer readable medium has instructions stored therein that are executable by processing circuitry of an electronic gaming machine (“EGM”) to cause the EGM to perform operations. The operations include determining that a position in a first grid of symbols includes a trigger symbol. The operations further include determining a type of symbol associated with the trigger symbol. The operations further include locking a symbol in the first grid of symbols based on the symbol being of the type of symbol associated with the trigger symbol. The operations further include, subsequent to locking the symbol, generating a second grid of symbols with the symbol at a predetermined position in the second grid of symbols based on the symbol being locked.

According to other embodiments, EGMs, systems, methods, and non-transitory computer-readable medium are provided for performing the above embodiments.

### BRIEF DESCRIPTION OF THE DRAWINGS

FIG. 1 is a schematic block diagram illustrating an example of a network configuration for a plurality of gaming devices according to some embodiments;

FIGS. 2A-E are diagrams illustrating examples of gaming devices according to some embodiments;

FIGS. 3A-D are schematic diagrams illustrating examples locking symbols for a single subsequent play of a slot game according to some embodiments;

FIGS. 4A-D are schematic diagrams illustrating examples locking symbols for a number of subsequent plays of a slot game according to some embodiments;

FIGS. 5A-D are schematic diagrams illustrating examples locking only specific symbols for subsequent plays of a slot game according to some embodiments;

FIGS. 6A-D are schematic diagrams illustrating examples locking symbols for subsequent plays of a slot game in response to a multiple matching trigger symbols according to some embodiments;

FIGS. 7A-D are schematic diagrams illustrating examples locking symbols for subsequent plays of a slot game until a trigger event is detected according to some embodiments; and

FIG. 8 is a flow chart illustrating an example of operations performed by an electronic gaming machine according to some embodiments.

### DETAILED DESCRIPTION

Electronic gaming machines (“EGMs”) can attract and retain players by offering the opportunity to win prizes. However, by their very nature, some wagering games (e.g., a slot game) provided by an EGM can appear entirely random and unrelated to a previous play of the wagering game. As a result, players can become bored with a game provided by the EGM that feels repetitive or unchanging.

Various embodiments herein describe methods for locking a symbol during play of a slot game such the symbol will be guaranteed to be displayed in a subsequent play of the slot game. In some embodiments, locking the symbol makes the player feel that a first play of a slot game affects a subsequent play of the slot game. An indication of one or more symbols being locked can help attract and retain players. In some examples, attracting and retaining players via locking symbols can increase the number of wagers per time (and/or energy used of the EGM).

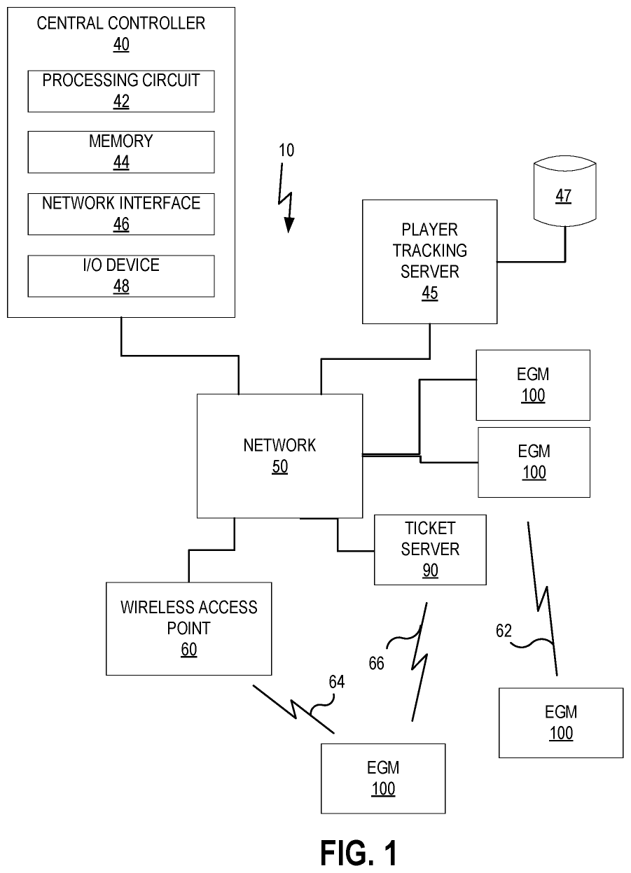

Before describing these and other embodiments in detail, reference is made to FIG. 1, which illustrates a gaming system 10 including a plurality of gaming devices 100. As discussed above, the gaming devices 100 may be one type of a variety of different types of gaming devices, such as electronic gaming machines (EGMs), mobile devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The central controller 40 can include processing circuit 42, memory 44, network interface 46, and an input/output (“I/O”) device 48. In some examples, the memory 44 includes instructions executable by processing circuit 42 for causing the central controller 40 to perform operations. The operations can include communicating with the data communication network 50 via the network interface 46 and/or communicating with a user/operator via the I/O device 48.

The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

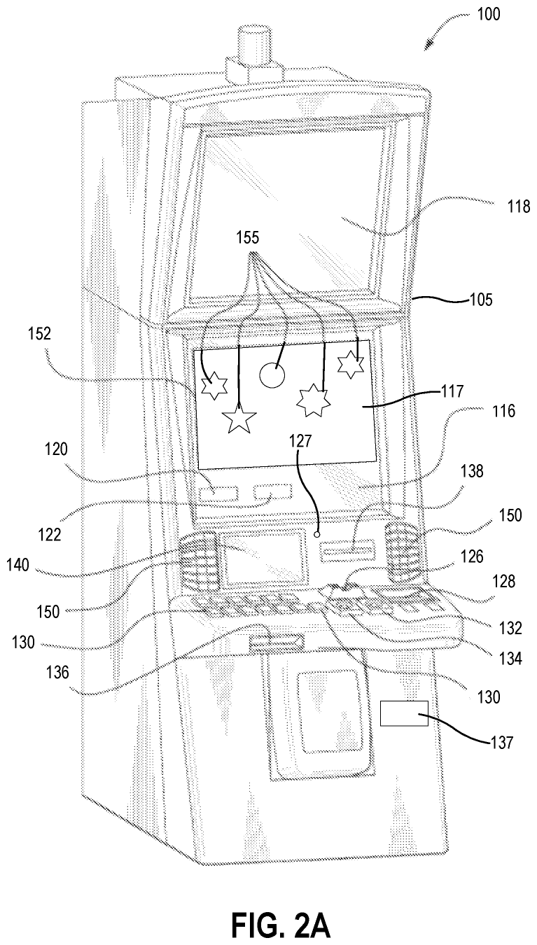

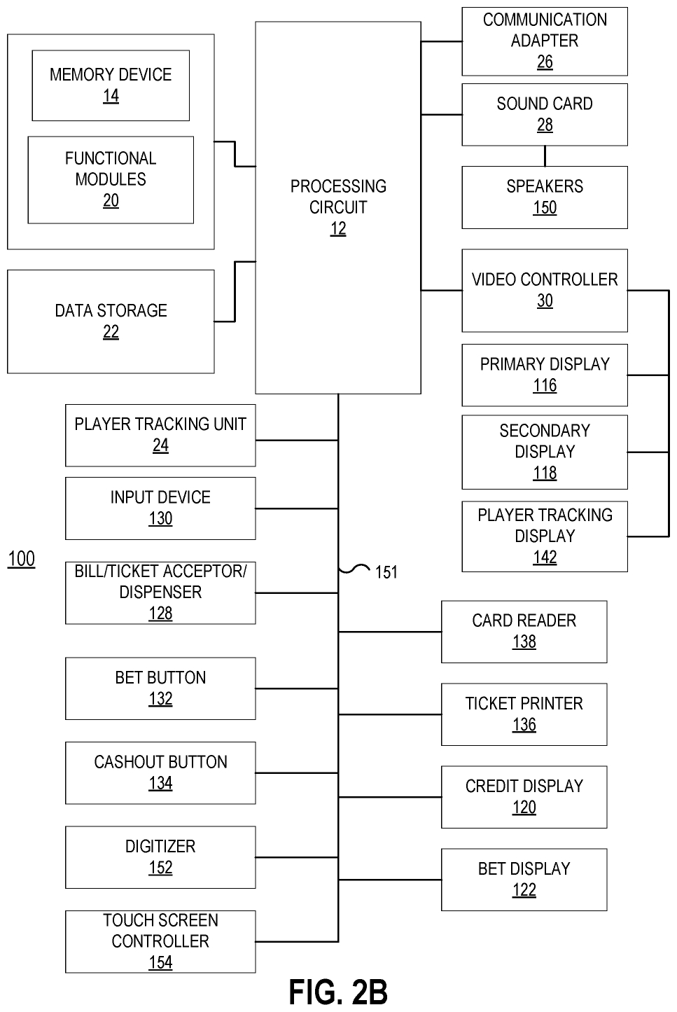

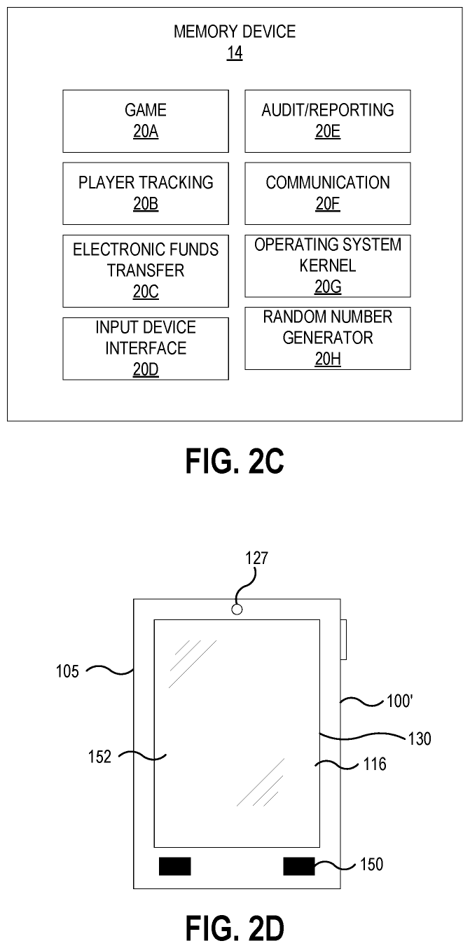

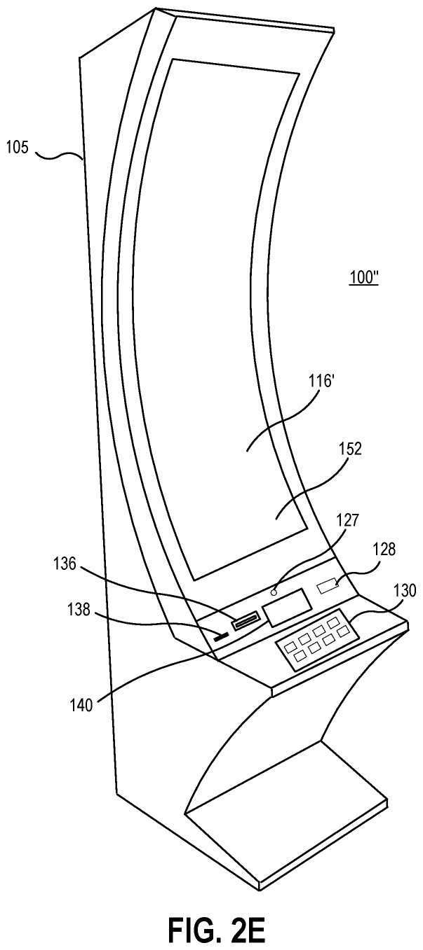

Embodiments herein may include different types of gaming devices. Various embodiments are illustrated in FIGS. 2A-2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A-C are provided as examples for illustrative purposes only. It will be appreciated that gaming devices may come in many different shapes, sizes, layouts, form factors, and configurations, and with varying numbers and types of input and output devices, and that embodiments of the inventive concepts are not limited to the particular gaming device structures described herein.

Gaming devices 100 typically include a number of standard features, many of which are illustrated in FIGS. 2A-B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30. The gaming device 100 may also include a player tracking unit 24 for managing communications and functionality between the processor circuit 12 and certain peripherals and components. Player tracking units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

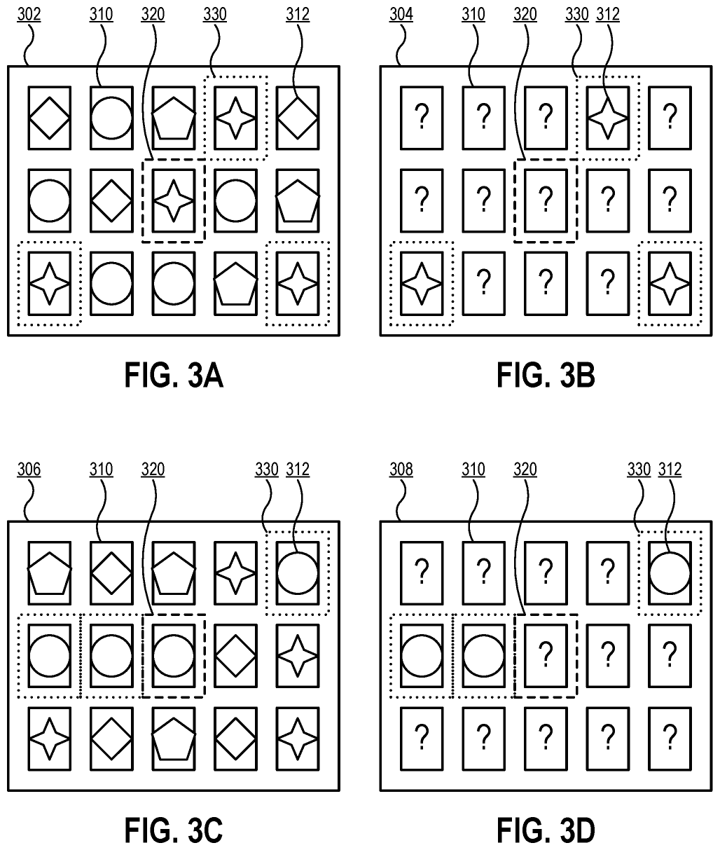

For example, referring to FIG. 2D, a gaming device 100′ may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits can be deposited in or transferred from the gaming device 100′ electronically.

FIG. 2E illustrates a standalone gaming device 100″, i.e., an EGM in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a player tracking display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGMs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Various embodiments herein describe an EGM locking a symbol as part of a first play of a slot game such that the symbol will be displayed as part of a second play of the slot game. In some embodiments, the first play and the second play of the slot game are performed on the same EGM. In some examples, the EGM indicates (before the second play of the slot game) that the symbol is locked. The indication can include an auditory or visual indication that may retain the user that played the first play and/or attract a new user to play the second play.

In other embodiments, the first play and the second play of the slot game are performed on different EGMs by a user (or different users) providing a common user identifier. In some examples, the EGM indicates to the user that the locked symbol is certain to appear in the second play. The indication can include a message provided (e.g., transmitted) to a device associated with the user identifier, which may encourage the user to perform the second play of the slot game.

FIGS. 3A-D illustrate an example of a series of display outputs as part of a slot game. In these examples, a symbol 312 is locked in response to a matching symbol being positioned in a trigger symbol position 320 of a first grid of symbols as part of a first play of a slot game. A locked symbol is guaranteed to appear in the same position within a second grid of symbols 306 as part of a second play of a slot game as it was within the first grid of symbols 302 as part of the first play of the slot game.

FIG. 3A illustrates an example of a first grid of symbols 302 including fifteen grid positions 310 (three rows of five columns each). In the first grid of symbols 302, each grid position 310 includes a symbol 312. In this example, one of the grid positions 310 is a trigger symbol position 320. A four-pointed star is the symbol 312 at the trigger symbol position 320. As a result of the four-pointed star being at the trigger symbol position 320, the other four-pointed stars in the first grid of symbols 302 are locked. Locking indicators 330 are displayed in association with the other four-pointed stars in the first grid of symbols.

FIG. 3B illustrates an example of a first transitioning grid of symbols 304 that is a version of the grid of symbols in-between the first grid of symbols 302 (associated with first play of a slot game) and a second grid of symbols 306 (associated with a second play of the slot game). The first transitioning grid of symbols 304 may be displayed by the EGM or may be a virtualization of a process of determining the second grid of symbols 306 based on the locked symbols of the first grid of symbols 302.

In this example, the first transitioning grid of symbols 304 includes the locked four-pointed stars from the first grid of symbols 302 each with their associated locking indicator 330. In this example, the four-pointed stars are in the same positions within the first transitioning grid of symbols 304 as they were in the first grid of symbols 302. In other examples, the four-pointed stars may be in different positions within the first transitioning grid of symbols 304 compared to the first grid of symbols 302. The other symbols in the first transitioning grid of symbols 304 are illustrated as question marks as they are not yet determined. In some examples, the other symbols may be rotating between different symbols as in a typical slot game.

FIG. 3C illustrates an example of a second grid of symbols 306 including the locked symbols of FIGS. 3A-B (though now without locking indicators as they are now unlocked). A circle is the symbol 312 at the trigger symbol position 320 in the second grid of symbols. As a result of the circle being at the trigger symbol position 320, the other circles in the second grid of symbols 306 are locked. Locking indicators 330 are displayed in association with the other circles in the first grid of symbols.

FIG. 3D illustrates an example of a second transitioning grid of symbols 308 that is a version of the grid of symbols in-between the second grid of symbols 306 (associated with second play of the slot game) and a third grid of symbols (associated with a third play of the slot game). The second transitioning grid of symbols 308 like the first transitioning grid of symbols 304 may be displayed by the EGM or may be a virtualization of a process of determining the third grid of symbols based on the locked symbols of the second grid of symbols 306.

In this example, the second transitioning grid of symbols 308 includes the locked circles from the second grid of symbols 306 each with their associated locking indicator 330. In this example, the circles are in the same positions within the second transitioning grid of symbols 308 as they were in the second grid of symbols 306. In other examples, the circles may be in different positions within the second transitioning grid of symbols 308 compared to the second grid of symbols 306. The other symbols in the second transitioning grid of symbols 308 are illustrated as question marks as they are not yet determined. In some examples, the other symbols may be rotating between different symbols as in a typical slot game.

In this example, the symbol (four-pointed star in the first grid of symbols 302 and the circle in the second grid of symbols 306) at the trigger symbol position 330 was not locked. In other examples, the symbol at the trigger symbol position 330 may be locked.

Although each of FIGS. 3-7 are illustrated as having a grid of symbols with fifteen grid positions, the innovations can be implemented with grids of symbols of any size or shape.

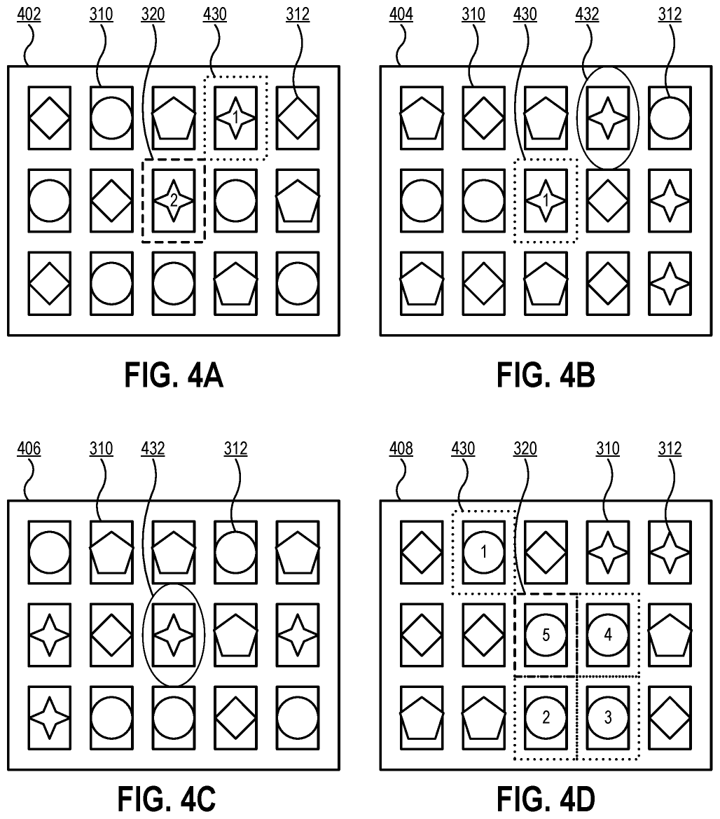

FIGS. 4A-D illustrate an example of a series of display outputs as part of a slot game. In these examples, a symbol 312 (including the triggering symbol) is locked in response to a matching symbol being positioned in a trigger symbol position 320 of a first grid of symbols 402 as part of a first play of a slot game. Each locked symbol is guaranteed to appear in the same position within a number of subsequent grids of symbols as part of a number of subsequent plays of a slot game as it was within the first grid of symbols 402 as part of the first play of the slot game. The number of subsequent grids of symbols (and/or the number of subsequent plays of the slot game) are, in this example, based on a number of the symbol in the first grid of symbols 402. A lock indicator 430 indicates which symbols 312 are locked and for how long they are locked. An unlocked indicator 432 indicates when a symbol 312 is unlocked (e.g., when the symbol 312 is no longer guaranteed to be in a subsequent grid of symbols).

FIG. 4A illustrates an example of a first grid of symbols 402 in which a four-pointed star is the symbol 312 at the trigger symbol position 320. As a result, the four-pointed star symbols 312 within the first grid of symbols 402 are displayed along with locked indicators 430. Since there are two four-point star symbols 312, one of the locked indicators 430 includes an indication that its corresponding four-point start symbol 312 is locked for two plays of the slot game and the other of the locked indicators 430 includes an indication that its corresponding four-point start symbol 312 is locked for one play of the slot game. In other embodiments, each of the locked symbols are locked for the same number of plays of the slot game.

FIG. 4B illustrates an example of a second grid of symbols 404 in which there is no trigger symbol position 320 because there were still locked symbols. In this example, each of the locked symbols had their corresponding number of plays for which they will be locked reduced by one. As a result, one of the locked indicators 430 was replaced by an unlocked indicator 432. The other locked indicator 430 had its corresponding number of plays for which its corresponding symbol will be locked reduced from two to one.

In other embodiments, there can still be a trigger symbol position 320 even if there are still locked symbols, which can result in multiple types of symbols 312 being locked at the same time.

FIG. 4C illustrates an example of a third grid of symbols 406 in which there is no trigger symbol position 320 because there were still locked symbols. In this example, the remaining locked symbol had its corresponding number of plays for which it will be locked reduced by one (to zero). As a result, the locked indicator 430 was replaced by an unlocked indicator 432.

FIG. 4D illustrates an example of a fourth grid of symbols 408 in which a circle is the symbol 312 at the trigger symbol position 320 (which is present because there were no longer any locked symbols). As a result, the circle symbol 312 within the first grid of symbols 402 are displayed along with locked indicators 430. Since there are five circle symbols 312, the locked indicators 430 each include an indication that its corresponding circle symbol 312 is locked for a number (e.g., 5, 4, 3, 2, and 1) of plays of the slot game.

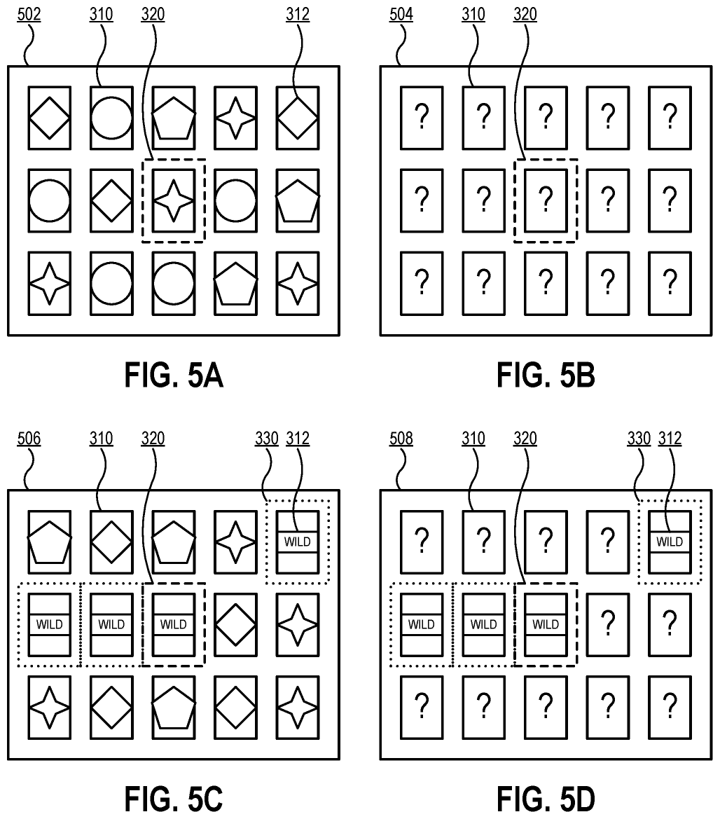

FIGS. 5A-D illustrate an example of a series of display outputs as part of a slot game. In these examples, a symbol 312 (including the triggering symbol) is locked in response to a specific matching symbol being positioned in a trigger symbol position 320 of a first grid of symbols 502 as part of a first play of a slot game. Here, the specific matching symbol is a wild symbol.

FIG. 5A illustrates an example of a first grid of symbols 502 in which no symbols are locked because a four-pointed star (rather than a wild) is positioned within the trigger symbol position 320. As a result of no symbols 312 being locked during a first play of the slot game, a first transitioning grid of symbols 504 illustrated in FIG. 5B does not include any locked symbols.

FIG. 5C illustrates an example of a second grid of symbols 506 in which four wild symbols are locked because a wild symbol (the specific triggering symbol) is positioned within the trigger symbol position 320. As a result, the four wild symbols are locked (and a corresponding lock indicator 530 is displayed) in FIGS. 5C-D.

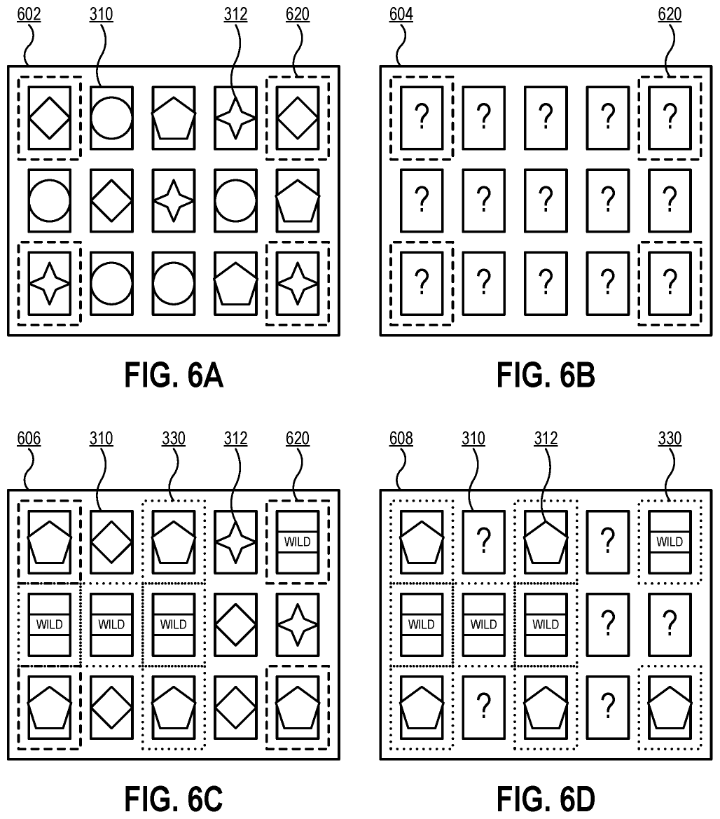

FIGS. 6A-D illustrate an example of a series of display outputs as part of a slot game. In these examples, symbols 312 (including the triggering symbols) are locked in response to a matching symbol being positioned in each of the trigger symbol positions 620 of a grid of symbols as part of play of a slot game. Here, the trigger symbol positions 620 are the corners of the grid of symbols.

FIG. 6A illustrates an example of a first grid of symbols 602 in which no symbols are locked because the trigger symbol positions 620 do not all match (two are diamonds and two are four-point stars). As a result of no symbols 312 being locked during a first play of the slot game, a first transitioning grid of symbols 604 illustrated in FIG. 6B does not include any locked symbols.

FIG. 6C illustrates an example of a second grid of symbols 606 in which the trigger symbol positions 620 all match (three pentagons and a while that, in this example, can count as a pentagon). As a result, the five pentagon symbols 312 and four wild symbols 312 (acting as at least pentagons) are locked in FIGS. 6C-D. In some examples, wilds do not count as another type of symbol for purposes of matching trigger symbols. In other examples, the matching trigger symbols can be made up of different types of trigger symbols.

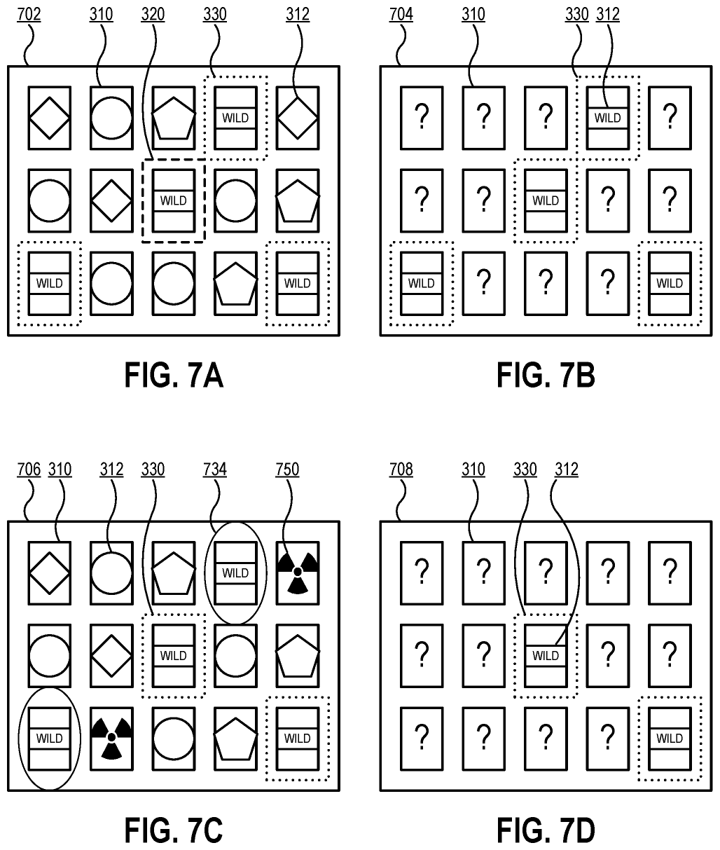

FIGS. 7A-D illustrate an example of a series of display outputs as part of a slot game. In these examples, symbols 312 (including the triggering symbols) are locked in response to a matching symbol being positioned in a trigger symbol positions 320 of a first grid of symbols as part of first play of a slot game. Here, the locked symbols remain locked in subsequent plays of the slot game until they are affected by a triggering event (e.g., proximity of an unlocking symbol 750).

FIG. 7A illustrates an example of a first grid of symbols 602 in which four wild symbols are locked because the trigger symbol position 320 includes a wild symbol. As a result of the wild symbols 312 being locked during a first play of the slot game, a first transitioning grid of symbols 704 illustrated in FIG. 7B includes the four locked wild symbols 312 with locked indicators 330.

FIG. 7C illustrates an example of a second grid of symbols 706 in which two unlocking symbols 750 are displayed. In this example, the two unlocking symbols 750 cause two of the wild symbols 312 that were locked to be unlocked (and corresponding unlocking indicators 734 to be displayed). The unlocking symbols 750 may only unlock symbols that are adjacent (or within a threshold distance) to the unlocking symbols 750 or may unlock a set number of locked symbols. As a result of the unlocking symbols 750 in the second grid of symbols 706, only two wilds remain locked in the second transitioning grid of symbols 708 of FIG. 7D.

In additional or alternative embodiments, triggering events (e.g., display of unlocking symbols) can adjust (e.g., increase or decrease) a number of subsequent plays of a slot game that a locked symbol remains locked (rather than fully unlocking the locked symbol).

In additional or alternative embodiments, the trigger positions are predetermined based on the slot game. In additional or alternative embodiments, the trigger positions may be based on a bonus condition being met or a time of day. In additional or alternative embodiments, the trigger positions may be provided and/or selected for a specific period of time as part of a promotion. In additional or alternative embodiments, the trigger positions may be based on user input. In some examples, the number and/or position of trigger positions may be based on an amount wagered by the user. In additional or alternative examples, the number and/or position of trigger positions may be selectable by the user prior to (or as part of) playing the slot game.

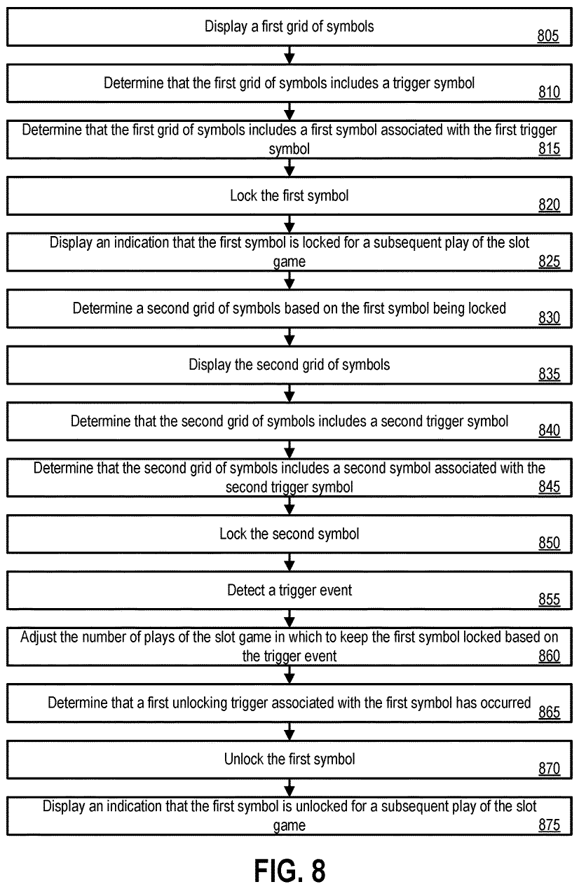

FIG. 8 illustrates examples of operations performed by an EGM according to some embodiments. Although the operations will be described in regards to processing circuit 12 and primary display 116 of EGM 100 of FIG. 2B, the operations can be performed by other elements of EGM 100 and/or by any suitable EGM.

At block 805, processing circuit 12 displays, via primary display 116, a first gird of symbols. In some embodiments, the first grid of symbols can be displayed as part of a first play of a slot game. In additional or alternative embodiments, the first grid of symbols can be displayed as part of a bonus game.

At block 810, processing circuit 12 determines that the first grid of symbols includes a trigger symbol. In some embodiments, determining that the first grid of symbols includes the trigger symbol includes determining that the trigger symbol is in a specific position within the grid of symbols. In additional or alternative embodiments, determining that the first grid of symbols includes the trigger symbol includes determining that a specific type of symbol is within the grid of symbols. In some examples, determining that the first grid of symbols includes the trigger symbol includes determining that the first grid of symbols includes a specific type of symbol (e.g., a wild) at a center of the first grid of symbols.

In additional or alternative embodiments, the trigger symbol includes a plurality of trigger symbols. Determining that the grid of symbols includes the trigger symbol includes determining that the plurality of trigger symbols are positioned in a specific plurality of positions within the grid of symbols. In some examples, determining that the first grid of symbols includes the trigger symbol includes determining that the first grid of symbols includes symbols of a set of symbol types (e.g., a set that includes stars and wilds) in the corners of the first grid of symbols.

At block 815, processing circuit 12 determines that the first grid of symbols includes a first symbol associated with the first trigger symbol. In some embodiments, determining that the first grid of symbols includes the first symbol associated with the first trigger symbol includes determining that a type of the first symbol matches a type of the first trigger symbol. In some examples, the first trigger symbol includes a wild and determining the first grid of symbols includes the first symbol includes determining that the first grid of symbols includes a wild (other than the trigger symbol).

In additional or alternative embodiments, the trigger symbol is a first trigger symbol of a plurality of trigger symbols. Determining that the grid of symbols includes the symbol associated with the trigger symbol includes: 1) determining a specific type of symbol associated with the first trigger symbol; 2) determining that the grid of symbols includes the symbol; and 3) determining that the symbol is of the specific type.

At block 820, processing circuit 12 locks the first symbol. In some embodiments, locking the symbol includes determining a number of plays of the slot game in which to include the first symbol as part of a corresponding grid of symbols and locking the symbol for the number of plays of the slot game. In additional or alternative embodiments, locking the symbol for the number of plays of the slot game includes determining the number of plays of the slot game based on a type of the trigger symbol. In additional or alternative embodiments, locking the symbol for the number of plays of the slot game includes determining the number of plays of the slot game in which to include the first symbol based on a type of the symbol. In additional or alternative embodiments, locking the symbol for the number of plays of the slot game includes determining the number of plays of the slot game in which to include the first symbol based on a characteristic of the grid of symbols.

In additional or alternative embodiments, determining that the grid of symbols includes the symbol associated with the trigger symbol includes determining that the grid of symbols includes a plurality of symbols associated with the trigger symbol. Locking the symbol includes locking each symbol of the plurality of symbols. In some examples, locking each symbol of the plurality of symbols includes locking a first symbol of the plurality of symbols for a first number of plays of the slot game and locking a second symbol of the plurality of symbols for a second number of plays of the slot game that is different than the first number.

In additional or alternative embodiments, locking the first symbol includes determining a condition and ensuring that the first symbol is displayed in subsequent plays of the slot game until the condition is met. In some examples, the condition includes a number of plays of the slot game. In additional or alternative examples, the condition includes a specific type of symbol appearing in a subsequent play of the slot game and/or the specific type of symbol appearing at a specific position (e.g., adjacent to the locked symbol).

In additional or alternative embodiments, locking the first symbol includes locking the symbol for a subsequent play of the slot game by a user associated with a specific user identifier. In some examples, the specific user identifier is associated with a user of the first play of the slot game. In additional or alternative examples, the subsequent play of the slot game includes subsequent play of the slot game on the same EGM that was used for the first play of the slot game. In other examples, the subsequent play of the slot game includes subsequent play of the slot game by a user using the user identifier on a different EGM than the EGM that was used for the first play of the slot game. In additional or alternative embodiments, locking the first symbol includes locking the symbol for a period of time (or plays) associated with a status of the user (or user identifier) playing the slot game.

At block 825, processing circuit 12 displays, via primary display 116, an indication that the first symbol is locked for a subsequent play of the slot game. In some examples, a lock icon is attached to the symbol. In some embodiments, if the symbol is locked into a specific position within the grid of symbols, the indication is associated with the position. In some examples, a set of bars is displayed over the position. In additional or alternative embodiments, a set of chains are displayed as surrounding the position. In some embodiments, displaying the indication that the first symbol is locked includes displaying an indication of a number of plays of the slot game that the first symbol will be locked. In some examples, a numerical indicator is added. In additional or alternative examples, a symbol (e.g., a fire with a specific number of flames) is added.

At block 830, processing circuit 12 determines a second grid of symbols based on the first symbol being locked. In some embodiments, determining the second grid of symbols based on the first symbol being locked includes first determining a position of the first symbol in the second grid of symbols then determining symbols to be displayed in the other positions of the second grid of symbols. In additional or alternative embodiments, determining the second grid of symbols to include the first symbol based on the first symbol being locked includes determining the second grid of symbols with the first symbol at the same position within the second grid of symbols as the first symbol was in the first grid of symbols.

At block 835, processing circuit 12 displays, via primary display 116, the second grid of symbols. In some embodiments, the second grid of symbols is displayed as part of a subsequent play of the slot game in response to a subsequent wager. In some examples, the first play of the slot game and the second play of the slot game were played by a user associated with the same user identifier. In other examples, the first play of the slot game and the second play of the slot game were played by a user associated with the different user identifiers.

At block 840, processing circuit 12 determines that the second grid of symbols includes a second trigger symbol. In some embodiments, the second trigger symbol is the same type of trigger symbol as the first trigger symbol. In other embodiments, the second trigger symbol is a different type of trigger symbol than the first symbol (e.g., the first trigger symbol may require a specific type of symbol in a first position whereas the second trigger symbol may require a specific type of symbol in a second position).

At block 845, processing circuit 12 determines that the second grid of symbols includes a second symbol associated with the second trigger symbol.

At block 850, processing circuit 12 lock the second symbol. In some embodiments, the second symbol is the first symbol and locking the second symbol includes adjusting the number of plays of the slot game in which to include the first symbol as part of the corresponding grid of symbols. In other embodiments, the second symbol is different than the first symbol and locking the second symbol includes locking the second symbol instead of the first symbol. In other embodiments, the second symbol is different than the first symbol and locking the second symbol includes locking the second symbol and locking the first symbol (e.g., keeping the first symbol locked).

At block 855, processing circuit 12 detects a trigger event. In some embodiments, the trigger event is a specific triggering symbol being in a specific position. In additional or alternative embodiments, detecting the trigger even includes determining that a specific type of symbol is in a position in the second grid of symbols.

At block 860, processing circuit 12 adjusts the number of plays of the slot game in which to keep the first symbol locked based on the trigger event. In some embodiments, the trigger event causes the number of plays to be increased. In other embodiments, the trigger event causes the number of plays to be decreased.

At block 865, processing circuit 12 determines that a first unlocking trigger associated with the first symbol has occurred. In some embodiments, the first unlocking trigger is the trigger event. In additional or alternative embodiments, the first unlocking trigger is a number of playthroughs being met since the first symbol was locked.

At block 870, processing circuit 12 unlocks the first symbol. In some embodiments, unlocking the first symbol includes no longer ensuring that the first symbol is part of a subsequent grid of symbols in a subsequent play of the slot game.

At block 875, processing circuit 12 displays, via primary display 116, an indication that the first symbol is unlocked for a subsequent play of the slot game. In some embodiments, displaying the indication that the first symbol is unlocked includes removing an indication that the first symbol is locked.

Various operations from the flow chart of FIG. 8 may be optional with respect to some embodiments of EGMs and related methods.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the FIGS. illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A method of operating an electronic gaming machine (“EGM”), the method including:
displaying a grid of symbols as part of a slot game;
determining that the grid of symbols includes a trigger symbol;
determining that the grid of symbols includes a symbol associated with the trigger symbol; and
responsive to determining that the grid of symbols includes the symbol associated with the trigger symbol and that the grid of symbols includes the trigger symbol, locking the symbol.

2. The method of claim 1, wherein locking the symbol includes determining a number of plays of the slot game in which to include the symbol as part of a corresponding grid of symbols.

3. The method of claim 2, wherein displaying the grid of symbols includes displaying a first grid of symbols as part of a first play of the slot game,
the method further including:
subsequent to locking the symbol, determining a second grid of symbols, as part of a second play of the slot game, to include the symbol based on the symbol being locked; and
displaying the second grid of symbols.

4. The method of claim 3, wherein determining the second grid of symbols to include the symbol based on the symbol being locked includes determining the second grid of symbols with the symbol at the same position within the second grid of symbols as the symbol was in the first grid of symbols.

5. The method of claim 3, wherein the trigger symbol includes a first trigger symbol,
wherein the symbol includes a first symbol,
the method further including:
determining that the second grid of symbols includes a second trigger symbol;
determining that the second grid of symbols includes a second symbol associated with the second trigger symbol; and
responsive to determining that the second grid of symbols includes the second symbol associated with the second trigger symbol and that the second grid of symbols includes the second trigger symbol, locking the second symbol.

6. The method of claim 5, wherein the second symbol is the first symbol,
wherein locking the second symbol includes adjusting the number of plays of the slot game in which to include the first symbol as part of the corresponding grid of symbols.

7. The method of claim 3, the method further including:
determining that the second play of the slot game includes a trigger event; and
responsive to determining that the second play of the slot game includes the trigger event, adjusting the number of plays of the slot game in which to include the symbol as part of the corresponding grid of symbols.

8. The method of claim 2, the method further including:
determining that the slot game has been played the number of plays; and
responsive to determining that the slot game has been played the number of plays, unlocking the symbol.

9. The method of claim 2, wherein locking the symbol includes determining the number of plays of the slot game in which to include the symbol based on a type of the trigger symbol.

10. The method of claim 2, wherein locking the symbol includes determining the number of plays of the slot game in which to include the symbol based on a type of the symbol.

11. The method of claim 2, wherein locking the symbol includes determining the number of plays of the slot game in which to include the symbol based on a characteristic of the grid of symbols.

12. The method of claim 2, wherein locking the symbol includes displaying an indication that the symbol is locked for the number of plays of the slot game.

13. The method of claim 1, wherein determining that the grid of symbols includes the trigger symbol includes determining that the trigger symbol is in a specific position within the grid of symbols.

14. The method of claim 1, wherein the trigger symbol includes a plurality of trigger symbols, and
wherein determining that the grid of symbols includes the trigger symbol includes determining that the plurality of trigger symbols are positioned in a specific plurality of positions within the grid of symbols.

15. The method of claim 1, wherein the trigger symbol is a first trigger symbol of a plurality of trigger symbols,
wherein determining that the grid of symbols includes the symbol associated with the trigger symbol includes:
determining a specific type of symbol associated with the first trigger symbol;
determining that the grid of symbols includes the symbol; and
determining that the symbol is of the specific type.

16. The method of claim 1, wherein determining that the grid of symbols includes the symbol associated with the trigger symbol includes determining that the grid of symbols includes a plurality of symbols associated with the trigger symbol, and
wherein locking the symbol includes locking each symbol of the plurality of symbols.

17. The method of claim 16, wherein locking each symbol of the plurality of symbols includes locking a first symbol of the plurality of symbols for a first number of plays of the slot game and locking a second symbol of the plurality of symbols for a second number of plays of the slot game that is different than the first number.

18. An electronic gaming machine (“EGM”) including:
processing circuitry; and
memory coupled to the processing circuitry and having instructions stored therein that are executable by the processing circuitry to cause the EGM to perform operations including:
displaying a first grid of symbols as part of a first play of a slot game;
determining that the first grid of symbols includes a scatter trigger symbol;
responsive to determining that the first grid of symbols includes the scatter trigger symbol, locking a symbol of the first grid of symbols; and
subsequent to completing the first play of the slot game, displaying a second grid of symbols as part of a second play of the slot game, the second grid of symbols being determined to include the symbol based on the symbol having been locked.

19. The EGM of claim 18, the operations further including:
prior to the second play of the slot game, displaying an indication that the symbol of the first grid of symbols is locked for a subsequent play of the slot game;
responsive to a condition being met, unlocking the symbol; and
subsequent to unlocking the symbol, displaying an indication that the symbol is unlocked for a subsequent play of the slot game.

20. A non-transitory computer readable medium having instructions stored therein that are executable by processing circuitry of an electronic gaming machine (“EGM”) to cause the EGM to perform operations including:
determining that a position in a first grid of symbols includes a trigger symbol;
determining a type of symbol associated with the trigger symbol;
locking a symbol in the first grid of symbols based on the symbol being of the type of symbol associated with the trigger symbol; and
subsequent to locking the symbol, generating a second grid of symbols with the symbol at a predetermined position in the second grid of symbols based on the symbol being locked.
